(19) United States
(12) Patent Application Publication
(10) Pub. No.: US 2025/0022259 A1
(43) Pub. Date: Jan. 16, 2025

(54) SYSTEMS AND METHODS FOR OBJECT IDENTIFICATION AND ANALYSIS

(71) Applicant: Included Health, Inc., San Francisco, CA (US)

(72) Inventor: Michael Rollins, San Francisco, CA (US)

(73) Assignee: Included Health, Inc., San Francisco, CA (US)

(21) Appl. No.: 18/352,974

(22) Filed: Jul. 14, 2023

(51) Int. Cl. G06V 10/776; G06V 10/25; G06V 10/46

(52) U.S. Cl. CPC G06V 10/776; G06V 10/25; G06V 10/462

(57) ABSTRACT

Methods, systems, and computer-readable media for automatically identifying and analyzing objects. The method includes receiving input data comprising image data having a plurality of objects, and identifying, from the image data, an object of interest of the plurality of objects. The method also includes identifying key frame data from the image data based on the identified object of interest. The method also includes analyzing, from the key frame data, the identified object of interest using one or more machine learning models. The method may also include iteratively analyzing the one or more objects using machine learning model(s) and refining the machine learning model(s) based on object validation. The method may also include tagging, registering, or generating output based on the one or more analyzed objects.

### FIELD OF DISCLOSURE

The disclosed embodiments generally relate to systems, devices, methods, and computer readable media for automatically identifying and analyzing objects using a machine learning approach.

### BACKGROUND

An ever increasing amount of data and data sources are now available to researchers, analysts, organizational entities, and others. This influx of information allows for sophisticated analysis but, at the same time, presents many new challenges for sifting through the available data and data sources to locate the most relevant and useful information in predictive modeling. As the use of technology continues to increase, so, too, will the availability of new data sources and information.

Moreover, a predictive model must be generic enough to effectively apply to a wide variety of future data sets and, at the same time, specific enough to provide accurate prediction. Striking the balance between high model performance and generalizability to new data is especially challenging when there are many millions or billions of features and many different types of models that need to be built. While current predictive models can be built using analysis, research, existing publications, and discussions with domain experts, this process can be resource and time intensive. Further, while the produced model may be effective for predicting a specific event, the time and resources necessary to produce similar predictive models for many thousands of additional events is not feasible. Currently, there is a need for accurate and efficient generation of predictive data models that can apply across domains and indicate what specific features of existing data most effectively predict a future event.

### SUMMARY

Certain embodiments of the present disclosure relate to a system comprising at least one memory storing instructions, system configured to execute the instructions to perform operations for automatically identifying and analyzing objects (e.g., medical objects). The operations may comprise receiving input data comprising image data having a plurality of objects, and identifying one or more objects associated with the input data. The operations may also comprise identifying, from the image data, an object of interest of the plurality of objects. The operations may also comprise identifying key frame data from the image data based on the identified object of interest, and analyzing, from the key frame data, the identified objects based on the key frame data using one or more machine learning models.

According to some disclosed embodiments, the image data may comprise a sequence of images corresponding to video data.

According to some disclosed embodiments, receiving input data may further comprise acquiring data and normalizing data.

According to some disclosed embodiments, generating the key frame data may be based on one or more confidence metrics associated with the one or more objects.

According to some disclosed embodiments, analyzing the identified objects may further comprise language processing or context analysis based on the key frame data.

According to some disclosed embodiments, analyzing the identified objects comprises extracting or parsing text data from the key frame data.

According to some disclosed embodiments, analyzing the identified objects may further comprise synthesizing text data from a plurality of images within the image data.

According to some disclosed embodiments, the system may further comprise iteratively executing second operations until a threshold value has been reached to generate an optimal object validation score, wherein the second operations comprise: analyzing the one or more objects using the one or more machine learning models, validating the one or more objects, updating an object validation score based on the validating of the one or more objects, and refining the one or more machine learning models based on the validation of the one or more objects.

According to some disclosed embodiments, the system may comprise tagging the one or more analyzed objects, registering the one or more analyzed objects, or generating output based on the one or more analyzed objects.

Other systems, methods, and computer-readable media are also discussed within.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a diagram illustrating various exemplary components of a system for automatically identifying and analyzing objects, according to some embodiments of the present disclosure.

FIG. 2 is a block diagram illustrating various exemplary components of a language processing engine comprising language processing modules, according to some embodiments of the present disclosure.

FIG. 3 is a block diagram illustrating an exemplary machine learning platform for implementing various aspects of this disclosure, according to some embodiments of the present disclosure.

FIG. 4 illustrates a schematic diagram of an exemplary server of a distributed system, according to some embodiments of the present disclosure.

FIGS. 5A-D illustrate an exemplary process for identifying and analyzing a medical object, and generating output, according to some embodiments of the present disclosure.

FIG. 6A-D illustrate an exemplary process for identifying and analyzing a medical object, and generating output, according to some embodiments of the present disclosure.

FIG. 7 is a flow diagram illustrating an exemplary process for identifying and analyzing objects, according to some embodiments of the present disclosure.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence nor constrained to a particular system configuration. Additionally, some of the described embodiments or elements thereof can occur or be performed simultaneously, at the same point in time, or concurrently. Reference will now be made in detail to the disclosed embodiments, examples of which are illustrated in the accompanying drawings. Unless explicitly stated, sending and receiving as used herein are understood to have broad meanings, including sending or receiving in response to a specific request or without such a specific request. These terms thus cover both active forms, and passive forms, of sending and receiving.

The embodiments described herein provide technologies and techniques for evaluating large numbers of data sources and vast amounts of data used in the creation of a machine learning model. These technologies can use information relevant to the specific domain and application of a machine learning model to prioritize potential data sources. Further, the technologies and techniques herein can interpret the available data sources and data to extract probabilities and outcomes associated with the machine learning model's specific domain and application. The described technologies can synthesize the data into a coherent machine learning model, that can be used to analyze and compare various paths or courses of action.

These technologies can efficiently evaluate data sources and data, prioritize their importance based on domain and circumstance specific needs, and provide effective and accurate predictions that can be used to evaluate potential courses of action. The technologies and methods allow for the application of data models to personalized circumstances. These methods and technologies allow for detailed evaluation that can improve decision making on a case-by-case basis. Further, these technologies can evaluate a system where the process for evaluating outcomes of data may be set up easily and repurposed by other uses of the technologies.

Technologies may utilize machine learning models to automate the process and predict responses without human intervention. The performance of such machine learning models is usually improved by providing more training data. A machine learning model's prediction quality is evaluated manually to determine if the machine learning model needs further training. Embodiments of these technologies described can help improve machine learning model predictions using the quality metrics of predictions requested by a user.

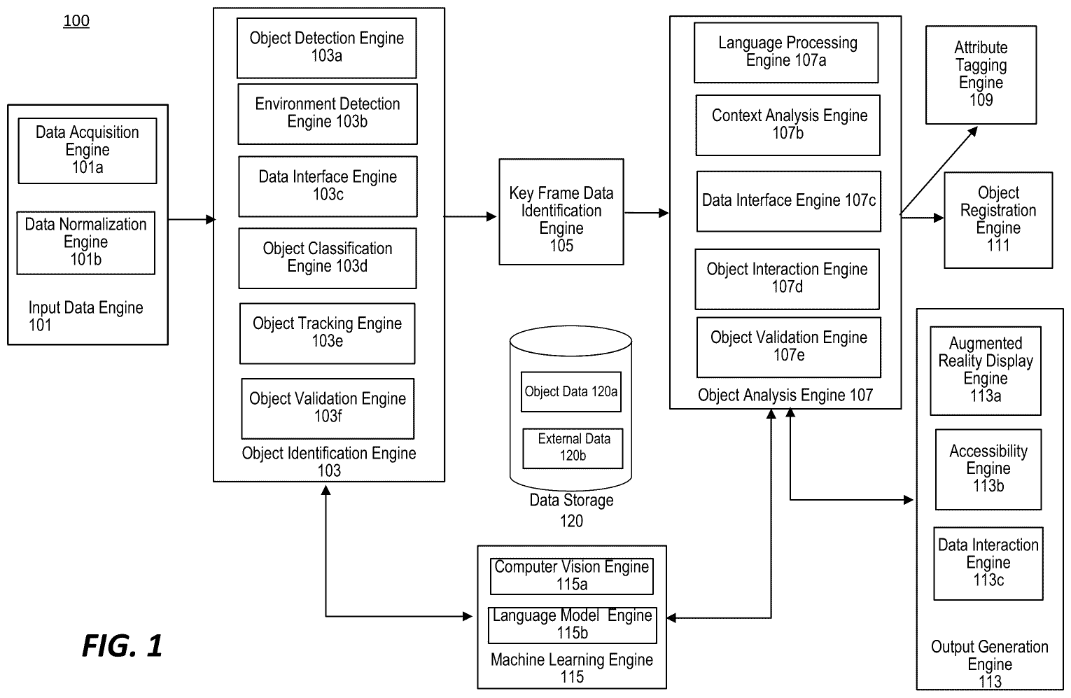

FIG. 1 is a diagram illustrating various exemplary components of a system for automatically identifying and analyzing objects, according to some embodiments of the present disclosure.

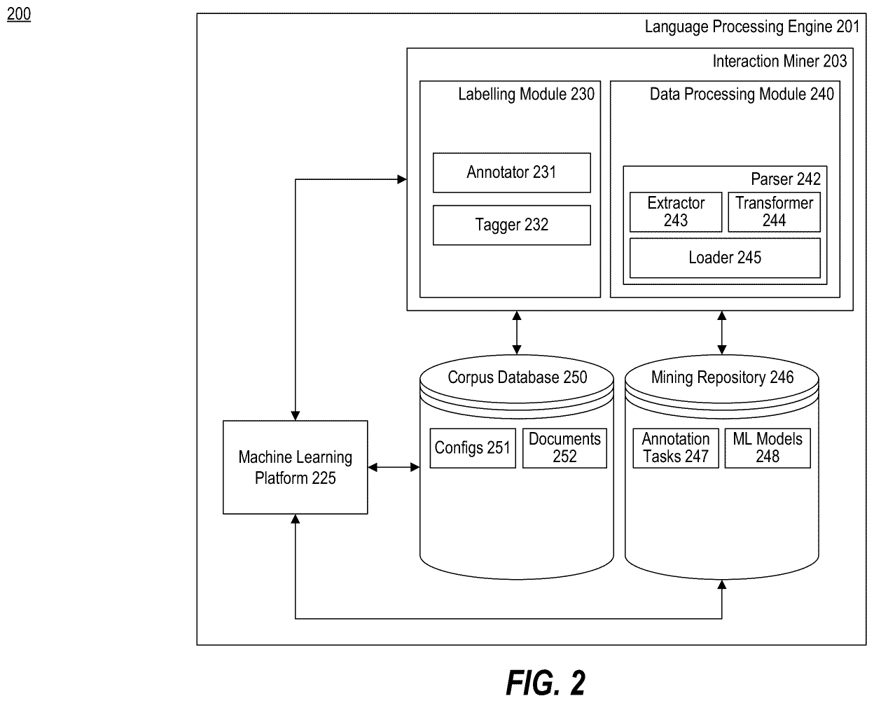

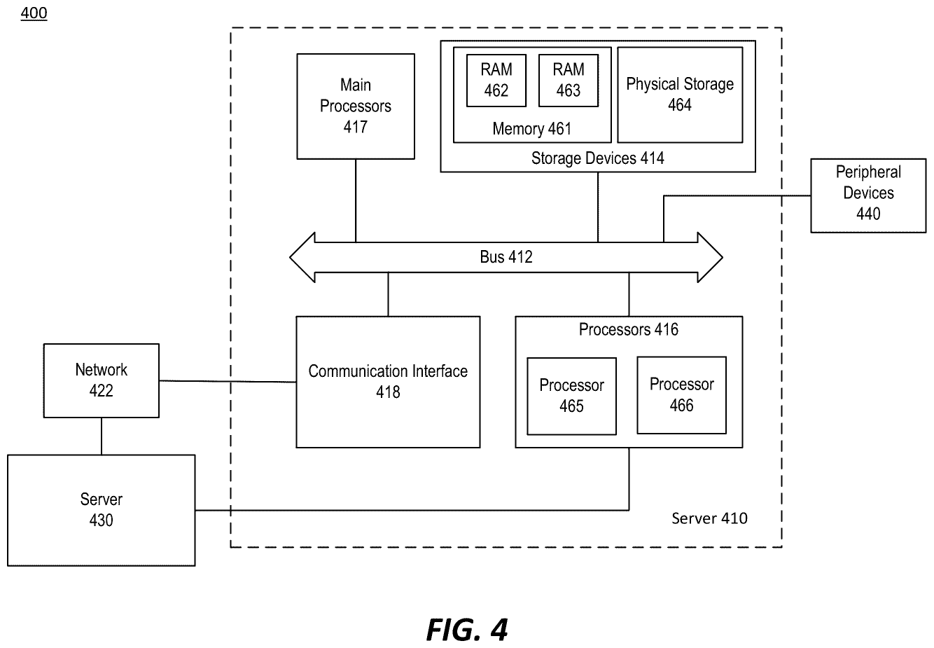

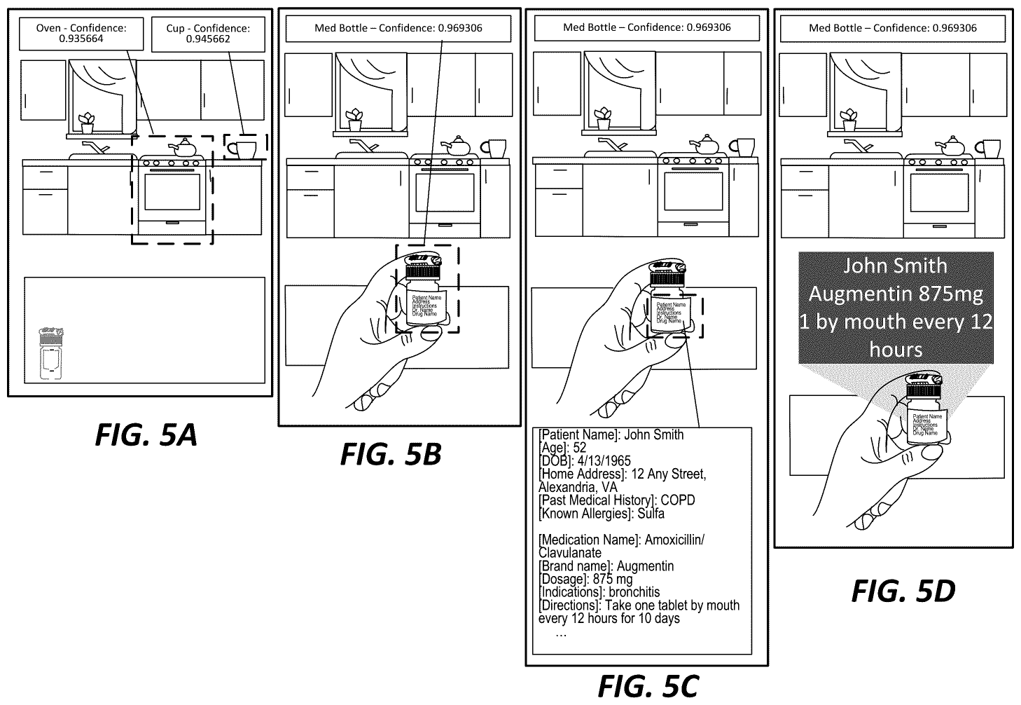

As shown in FIG. 1, system 100 may include input data engine 101. As discussed below with respect to FIG. 4, an engine may be a module (e.g., a program module), which may be a packaged functional hardware unit designed for use with other components (e.g., system and a memory component) or a part of a program that performs a particular function (e.g., of related functions). Input data engine 101a may receive input data from one or more data sources such as an imaging device (e.g., a camera on a mobile phone) or from a wearable device such as an AR/VR (virtual-reality/augmented-reality) headset. Input data engine 101 may comprise data acquisition engine 101a. Data acquisition engine 101a may receive image data or video data from one or more data sources. For instance, image data may contain a plurality of objects within the image (e.g., “cup,”, “oven,” etc as shown in FIG. 5A). In some embodiments, image data may comprise a sequence of images corresponding to video data. Input engine 101 may comprise data normalization engine 101b. Data normalization engine 101b may normalize the received data. In some embodiments, data normalization comprises normalizing various parameters of the received data such as the data format, length, and quality. In some embodiments, data normalization engine 101b may normalize data such as dates. For example, data may comprise date data in day-month-year format or year-month-day format. In this example, data normalization engine 101b can effectively clean the data and may modify the data into a consistent date format, so that all of the data, although originating from a variety of sources, has a consistent format. Moreover, data normalization engine 101b can extract additional data points from the data. For example, data normalization engine 101b may process a date in year-month-day format by extracting separate data fields for the year, the month, and the day. Data normalization engine 101b may also perform other linear and non-linear transformations and extractions on categorical and numerical data such as normalization and demeaning. In some embodiments, data normalization engine 101b may provide the transformed and/or extracted data to data loader 213 as shown in FIG. 2. In some embodiments, data normalization engine 101b may be exemplified by transformer 244 as shown in FIG. 2.

According to some embodiments, system 100 may include object identification engine 103. In some embodiments, object identification engine 103 may identify one or more objects within the received input data from input data engine 101. For instance, in a healthcare setting, object identification engine 103 may identify one or more objects (e.g., such as medical objects including a medication bottle, a medical instrument, a medical chart, or a set of written instructions from the physician). Object identification engine 103 may comprise object detection engine 103a. In some embodiments, object detection engine 103a may detect one or more objects within the received input data. Object detection engine 103a may perform object detection within the received input data using machine learning engine 115. In some embodiments, object detection engine 103a may perform object detection using computer vision engine 115a. In some embodiments, object detection engine 103a may detect a plurality of objects within the received input data.

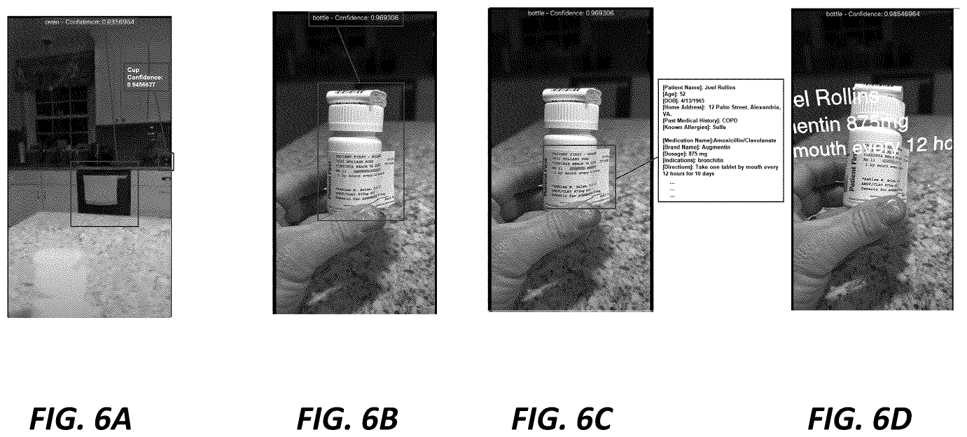

In some embodiments, object detection engine 103a may perform object detection based on one or more confidence metrics and generate one or more labels associated with the identified objects based on a confidence level from the one or more confidence metrics. In some embodiments, the one or more confidence metrics may be used by machine learning engine 115, computer vision engine 115a, or language model engine 115b. The one or more confidence metrics may be stored in data storage 120. In some embodiments, object detection engine 103a may perform object detection and object labeling when the confidence level from the one or more confidence metrics is above a certain threshold. In some embodiments, object detection engine 103a may differentiate an object from a non-object based on one or more confidence metrics. For instance, as illustrated in FIGS. 5A-D and FIGS. 6A-D and discussed below, object detection engine 103a may perform object detection (e.g., a cup, an oven, or a medication bottle) within the received input data and label the detected objects accordingly as “cup,” “oven,” and “med bottle” when the confidence level for each object identification is above a threshold of 0.9 (i.e., 90%). At the same time, as shown in FIG. 5A, object detection engine 103a may not detect the medication bottle in the lower left of the figure as an object and label it accordingly, because various factors (poor lighting, non-centering focus, etc) of one or more confidence metrics may produce a sub-threshold confidence level. However, as shown in FIG. 5B, object detection engine 103a may detect and label the medication bottle and differentiate it from a non-object once the one or more confidence metrics produce an above-threshold confidence level (e.g., due to improved lighting, centered focus, etc). In some embodiments, a confidence metric may be based on environment data generated by environment detection engine 103b. For instance, the detection of a “kitchen” environment by environment detection engine 103b may be used by a confidence metric to generate a (e.g. higher) confidence level for objects such as “oven” and “cup.” As another example, object detection engine 103a may detect medication pills based on recognition of its unique shape, size, color, or etched label. In some embodiments, object detection engine 103a may detect an object of interest of the plurality of objects. For instance, as shown in FIG. 5A below, object detection engine 103a may detect a plurality of objects including “oven” and “cup”, but detect a medication bottle (“med bottle”) as an object of interest as shown in FIG. 5B. In some embodiments, object detection engine 103a may detect an object of interest based on user preference, which may be stored in data storage 120 or received as data by input data engine 101. In some embodiments, object detection engine 103a may detect an object of interest based on environment data (e.g., a hospital setting, a clinical setting, or an emergency room setting) received by environment detection engine 103b.

According to some embodiments, object identification engine 103 may comprise environment detection engine 103b. In some embodiments, environment detection engine 103b may identify the surrounding environment associated with one or more objects. For instance, environment detection engine 103b may detect the real world environment associated with one or more objects within the received input data (e.g., image data or video data), such as a kitchen, office, hospital, etc. In some embodiments, environment detection engine 103b may perform environment detection and labeling (e.g., “kitchen,” “office,” “hospital”) when a confidence level from one or more confidence metrics is above a certain threshold.

According to some embodiments, object identification engine 103 may comprise data interface engine 103c. Data interface engine 103c may synthesize data from different sources. In some embodiments, data interface engine 103c may receive data from one or more engines. In some embodiments, data interface engine 103c may transmit data to one or more engines. For instance, data interface engine 103c may receive environment data from environment detection engine 103b and transmit the data to object detection engine 103a. Object detection engine 103a may then perform object detection and/or labeling based on a confidence level from a confidence metric based on the transmitted environment data. For instance, object detection engine 103a may detect and label objects such as “oven” and “cup” with a higher confidence level based on the transmitted environment data comprising “kitchen.” In some embodiments, data interface engine 103c may receive or transmit data from data storage 120.

According to some embodiments, object identification engine 103 may comprise object classification engine 103d. In some embodiments, object classification engine 103d may perform classification of objects detected by object detection engine 103a. In some embodiments, object classification engine 103d may generate one or more labels associated with the identified objects based on one or more confidence metrics and a confidence level from the one or more confidence metrics. In some embodiments, the one or more confidence metrics may be used by machine learning engine 115, computer vision engine 115a, or language model engine 115b. The one or more confidence metrics may be stored in data storage 120. In some embodiments, object classification engine 103d may classify the one or more identified objects using a classification scheme stored in data storage 120. For instance, in a healthcare setting, a classification scheme may comprise of a list of current medications associated with a user of system 100 based on user data (e.g., “John [user A]'s Augmentin medication”), or a list of medical devices, instruments, or equipment. In some embodiments, user data may be stored in data storage 120. In some embodiments, the classification scheme may be based on environment data from environment detection engine 103b. For instance, as illustrated in FIGS. 5A-D and FIGS. 6A-D and discussed below, object classification engine 103d may classify objects based on a classification scheme (e.g., a medication bottle) and label the detected objects accordingly as “med bottle” based on the classification. Object classification engine 103d may further classify an object such as “med bottle” based on user data (e.g., “John [user A]'s med bottle”).

According to some embodiments, object identification engine 103 may comprise object tracking engine 103e. In some embodiments, object tracking engine 103e may receive object data associated with one or more identified objects from object detection engine 103a. Object tracking engine 103e may receive environment data from environment detection engine 103b. Object tracking engine 103e may receive object data from object classification engine 103d. Object tracking engine 103e may perform tracking of one or more identified or classified objects in an environment based on the received object data and environment data. For instance, for input data comprising video data, object tracking engine 103e may continuously determine the spatial coordinates for one or more identified or classified objects (e.g., a medication bottle held by a user, as illustrated in FIG. 5B and FIG. 6B) within an environment to maintain tracking of the one or more objects within the environment. As another example, object tracking engine 103e may track one or more medication pills outside of the context of its medication bottle (e.g., a “loose pill”) based on the detection of the pill by object detection engine 103 using its unique shape, size, color, or etched label, or the classification of the pill by object classification engine 103d (e.g., identifying the pill as “Augmentin.”)

According to some embodiments, object identification engine 103 may comprise object tracking engine 103e. In some embodiments, object tracking engine 103e may receive object data associated with one or more detected objects from object detection engine 103a. Object tracking engine 103e may receive environment data from environment detection engine 103b. Object tracking engine 103e may receive object data from object classification engine 103d. Object tracking engine 103e may perform tracking of one or more detected or classified objects in an environment based on the received object data and environment data. For instance, for input data comprising video data, object tracking engine 103e may continuously determine the spatial coordinates for one or more detected or classified objects (e.g., a medication bottle held by a user, as illustrated in FIG. 5B and FIG. 6B) within an environment to maintain tracking of the one or more objects within the environment.

According to some embodiments, object identification engine 103 may comprise object validation engine 103f. In some embodiments, object validation engine 103f may validate the one or more objects detected by object detection engine 103a. In some embodiments, object validation engine 103f may validate the one or more objects classified by object classification engine 103c. Object validation engine 103f may perform validation for one or more objects detected or classified based on one or more confidence metrics. Object validation engine 103f may generate an object validation score for one or more objects detected or classified based on one more confidence metrics. Object validation engine 103f may update an object validation score based on the validating of one or more objects. In some embodiments, object validation engine 103f may transmit validation data for one or more objects to machine learning engine 115. In some embodiments, machine learning engine 115 may refine one or more machine learning models or language models based on the receive validation data. In some embodiments, object validation engine 103f may iteratively execute object validation until a threshold validation has been reached to generate an optimal object validation score for one or more objects.

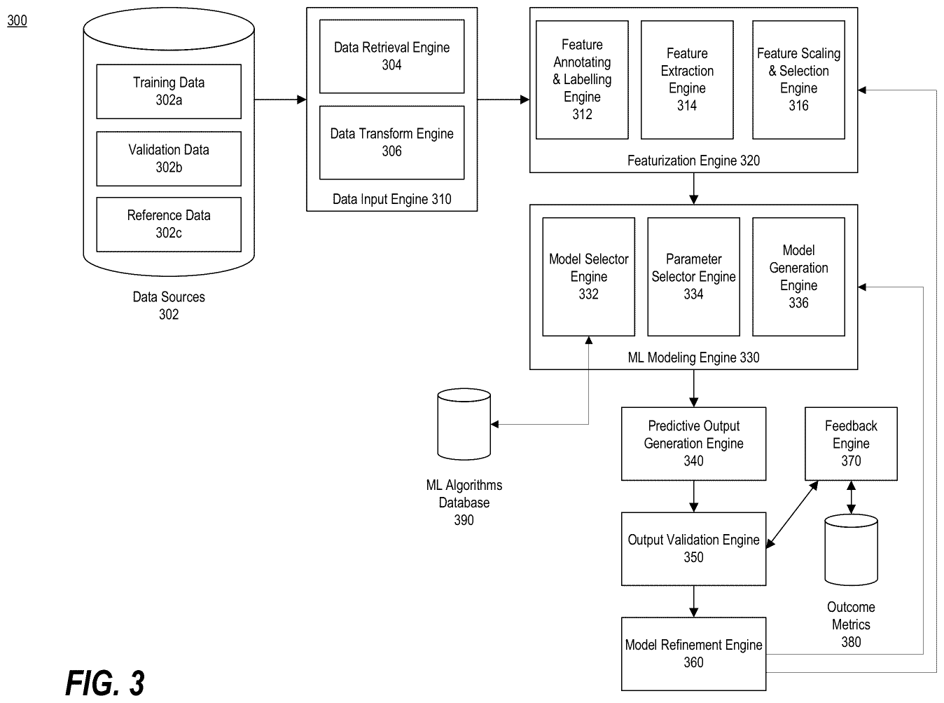

According to some embodiments, system 100 may include key frame data identification engine 105. In some embodiments, key frame data identification engine 105 may identify key frame data. For instance, for input data comprising video data (e.g., acquired via a video recording device or a camera mobile app), key frame data identification engine 105 may identify a key video frame within the video input data containing objects of relevance. In some embodiments, objects of relevance within the key frame data may comprise objects identified by object detection engine 103a or objects classified by object classification engine 103d. For instance, for video input data, key frame data may comprise one or more video frames where one or more objects have been detected or classified by object identification engine 103 (e.g., a “cup,” an “oven,” or a “med bottle”). In some embodiments, key frame data identification engine 105 may identify key frame data based on environment data. Key frame data identification engine 105 may interact with machine learning engine 115 and computer vision engine 115a to execute iterative cycles of key frame data identification, validation, and refinement, as illustrated in exemplary machine learning system 300 in FIG. 3. In some embodiments, key frame data identification engine 105 may identify key frame data based on one or more confidence metrics associated with one or more identified or classified objects from object identification engine 103. For instance, key frame data identification engine 105 may identify key frame data comprising data associated with identified or classified objects having a confidence level above a certain threshold (e.g., 0.9 or 90%). In some embodiments, key frame data identification engine 105 may identify key frame data based on external data (e.g., user-defined data) stored in data storage 120. For instance, key frame data may be identified based on user specification of specific objects of relevance (e.g., a medication bottle associated with a user, such as “John [user A]'s Augmentin medication.”).

According to some embodiments, system 100 may include object analysis engine 107. Object analysis engine 107 may receive object detection data or environment data from object identification engine 103. Object analysis engine 107 may receive key frame data from key frame data identification engine 105. Object analysis engine 107 may analyze one or more identified objects to generate relevant analysis data. For instance, in a healthcare setting, object analysis engine 107 may analyze an identified medication bottle to generate analysis data based on the label on the medication bottle (e.g., comprising the name of the medication, instructions, contraindications, etc). Object analysis engine 107 may perform iterative cycles of object analysis, validation, and model refinement, using machine learning engine 115. Output analysis engine 107 may generate output data for additional output generation by output generation engine 113. Output analysis engine 107 may generate output object data for attribute-tagging by attribute tagging engine 109, or for registration by object registration engine 111.

According to some embodiments, object analysis engine 107 may comprise language processing engine 107a. In some embodiments, language processing engine 107a may be exemplified by language processing engine 201 as shown in FIG. 2 and discussed below. In some embodiments, language processing engine 107a may perform analysis of text data associated with one or more objects identified by object identification engine 103. In some embodiments, text data is a subset of key frame data identified by key frame data identification engine 105. For instance, text data may comprise medication label data associated with an identified medication bottle associated with a user. As another example, text data may comprise a set of physician's instructions or a set of patient's medical history associated with one or more medical objects identified by object identification engine 103. In some embodiments, language processing engine 107a may perform keyword identification within text data and access of database (e.g., as exemplified by data storage 120). Language processing engine 107a may retrieve object data based on keyword identification. For instance, language processing engine 107a may identify “Augmentin” as a keyword and access a database to search for data associated with Augmentin (e.g., its full drug name, the user or patient's previous usage of the drug, associated adverse reactions, etc). In some embodiments, language processing engine 107a may extract text data from key frame data or parse text data from key frame data.

According to some embodiments, object analysis engine 107 may comprise context analysis engine 107b. In some embodiments, context analysis engine 107b may receive object data or environment data from object identification engine 103. In some embodiments, context analysis engine 107b may receive key frame data from key frame data identification engine 105. Context analysis engine 107b may identify the spatial boundaries associated with one or more objects of interest within the key frame data. For instance, context analysis engine 107b may identify the spatial boundaries or background information associated with an object (e.g., a medical object such as a medication bottle). For example, within key frame data containing an object (e.g., a medical object such as a medication bottle), context analysis engine 107b may identify the boundaries of the medication label associated with the mediation bottle and transmit the boundary data to language processing engine 107a to perform text analysis on the medication label. Context analysis engine 107b may also identify background data associated with the object (e.g., the medication bottle) within the key frame data using environment data from environment detection engine 103b. For instance, context analysis engine 107b may identify the user's hand holding the medication bottle or the setting as “kitchen” or “hospital.” In some embodiments, context analysis engine 107b may also provide supplemental data associated with an object data by retrieving data from data storage 120, or receiving data from attribute tagging engine 109 or object registration engine 111. For instance, as shown in FIG. 5C and FIG. 6C below, object analysis engine 107 may analyze the text label on a medication bottle comprising of limited patient information (e.g., patient name, address, drug name, etc). Context analysis engine 107b may provide comprehensive supplemental data associated with the object (i.e., the text label of the medication bottle) by retrieving or receiving additional data (e.g., the patient's past medical history, allergies, the drug's indications, detailed instructions etc). In some embodiments, context analysis engine 107b may provide supplemental data by interfacing with an external server (e.g., a healthcare data server) as exemplified by server 410 or server 430 in FIG. 4 using communication interface 418.

According to some embodiments, object analysis engine 107 may comprise data interface engine 107c. Data interface engine 107c may synthesize data from different sources. In some embodiments, data interface engine 107c may receive data from one or more engines. In some embodiments, data interface engine 103c may transmit data to one or more engines. For instance, data interface engine 103c may receive text analysis data from language processing engine 107a and context analysis data from context analysis engine 107b. Object analysis engine 107 may perform object analysis based on a confidence level from a confidence metric based on the text analysis data or context analysis data. For instance, object analysis engine 107 may identify the medication label associated with a medication bottle based on context analysis data generated by context analysis engine 107b and analyze the medication label based on text analysis data generated by language processing engine 107a. As illustrated in FIG. 5C and FIG. 6C, object analysis engine 107b may synthesize data using data interface engine 107c and output analysis data associated with the object of interest (e.g., name of the patient, name of the medication, instructions, contraindications, etc). In some embodiments, data interface engine 107c may receive or transmit data from data storage 120.

According to some embodiments, object analysis engine 107 may comprise object interaction engine 107d. In some embodiments, object interaction engine 107d may generate object interaction data based on a subset of objects identified in key frame data identified by key frame data identification engine 105. For instance, object interaction engine 107d may identify multiple objects (e.g., a medication bottle and the user or patient) and perform multiplex analysis on these objects. Object interaction engine 107d may generate interaction data associated with the subset of objects (e.g., associating the user as the patient for whom the medication is prescribed). In some embodiments, object interaction engine 107d may transmit interaction data to context analysis engine 107b or object validation engine 107e.

According to some embodiments, object analysis engine 107 may comprise object validation engine 107e. In some embodiments, object validation engine 107 may validate the one or more objects analyzed by object analysis engine 107. Object validation engine 107e may perform validation for one or more analyzed objects based on one or more confidence metrics. Object validation engine 107 may generate an object validation score for one or more objects based on one more confidence metrics. Object validation engine 107 may update an object validation score based on the validating of one or more objects. In some embodiments, object validation engine 107 may transmit validation data for one or more objects to machine learning engine 115. In some embodiments, machine learning engine 115 may refine one or more machine learning models or language models based on the receive validation data. In some embodiments, object validation engine 107 may iteratively execute object validation until a threshold validation has been reached to generate an optimal object validation score for one or more objects.

According to some embodiments, system 100 may include attribute tagging engine 109. Attribute tagging engine 109 may receive output analysis data and identify relevant attributes associated with one or more objects of interest. For instance, in a healthcare setting, attribute tagging engine 109 may identify a set of attributes associated with a medication bottle (e.g., “med bottle”) such as the name of the medication, the name of the patient (e.g. user) for whom the medication is prescribed, the instructions for taking the medications, and any associated warnings. Attribute tagging engine 109 may attach the set of attributes to the object of interest. For instance, the attached attributes may be transmitted to Augmented Reality display engine 113a to be displayed as an AR overlay of the object of interest (e.g., the medication bottle) via a user's camera mobile device or a wearable. The attached attributes may also be transmitted to accessibility engine 113b (e.g., a text to speech system), or data interaction engine 113c for further processing of the attributes (e.g., for generating audio output or for transmitting the data to an electronic healthcare system).

According to some embodiments, system 100 may include object registration engine 111. In some embodiments, object registration engine 111 may receive output analysis data from object analysis engine 107 and access a database such as one exemplified by data storage 120. Object registration engine 111 may register object data by storing output analysis data associated with one or more objects in data storage 120. Object registration engine 111 may update object data 120a based on output analysis data. In some embodiments, object registration engine 111 may register partial object data for iterative cycles of object analysis by object analysis engine 117. For instance, object registration engine 111 may register partial object data comprising a partial view or an oblique perspective of an object (e.g., a medication bottle with only part of its text label visible to the user, a side-view of a medication pill with its etched label obscured). In this instance (e.g., of a medication bottle), object registration engine 111 may register the partial object data and interact with object analysis engine 117 for iterative cycles of object analysis (e.g., continuously analyzing the medication bottle as the remaining portion of the text label become visible to the user when the user manually rotates the medication bottle or shifts his point-of-view to gain a full view of the object). In some embodiments, object registration engine 111 may synthesize text data from a plurality of images within the image data by registering partial object data (e.g., a partially-analyzed partially-visible text label on a medication bottle) and synthesizing the partial object data into complete object data (e.g., a fully-analyzed text label on a medication bottle).

According to some embodiments, system 100 may include output generation engine 113. Output generation engine 113 may receive object analysis data from object analysis engine 107. Output generation engine 113 may generate output directed to various formats and output devices (e.g., VR/AR display, Text-to-Speech systems, or data transmission to electronic healthcare systems).

According to some embodiments, output generation engine 113 may comprise augmented reality (AR) display engine 113a. AR display engine 113a may receive output analysis data from object analysis engine 107 and generate AR display based on the output analysis data. As illustrated in FIG. 5D and FIG. 6D, AR display engine 113a may generate an AR overlay display over input video data (e.g., acquired via a camera or video app on a mobile device or a wearable device) containing information relevant to an object of interest. For instance, as shown in FIGS. 5D and 6D, AR display engine 113a may generate an AR display over the detected object (e.g., a medication bottle) containing the name of the patient (i.e., the user), the name of the medication, and the instructions for taking the medication.

According to some embodiments, output generation engine 113 may comprise accessibility engine 113b. In some embodiments, accessibility engine 113b may comprise one or more systems to assist a user with disabilities. For instance, accessibility engine 113b may comprise a text to speech system. The text to speech system may receive output analysis data from object analysis engine 107 and convert the data to an audio output format. For instance, in a healthcare setting with a patient who is vision-impaired, the text to speech system may receive output analysis data associated with a medication label, and output relevant information (e.g., the name of the medication, the instructions for taking the medication, and any associated warnings) to the user in audio format. The text to speech system may also receive vocal user instructions and generate additional audio feedback based on the output analysis data. For instance, the text to speech system may enable a user who is holding an object (e.g., a medication bottle) to query “what medication is this?” and generate the appropriate audio response based on the output analysis data associated with the object.

According to some embodiments, output generation engine 113 may comprise data interaction engine 113c. Data interaction engine 113c may transmit output analysis data from object analysis engine 107 to external applications such as mobile apps, computer programs, or other database systems. For instance, in a healthcare setting, data interaction engine 113c may transmit object analysis data comprising medication data associated with user (e.g., John [user A]'s Augmentin) to an external healthcare database for verification or updating. As another example, data interaction engine 113c may transmit output analysis data relating to an object (e.g., a medical object such as a medication bottle) to a mobile app such as a scheduling or calendar app. Data interaction engine 113c may enable automatic alerts to the user based on the analyzed object data. For instance, if medication bottle contains instructions for “BID for 10 days,” data interaction engine 113c may interact with the user's scheduling or calendar app to automatically generate twice-daily alerts or reminders for 10 days. As another example in the healthcare setting, output generation engine 113 may synthetize analyzed object data with external data 120b (e.g., a user or patient's past medical history, allergies, list of other current medications etc) and generate warnings to the user for potentially dangerous drug combinations or contraindications. As another example, output generation engine 113 may transmit output analysis data (e.g., medication data, healthcare data, or patient demographic data) to an electronic form for automatic completion, or to a healthcare provider for further management.

According to some embodiments, system 100 may comprise machine learning engine 115. In some embodiments, machine learning engine 115 interacts with object identification engine 103, key frame data identification engine 105, and object analysis engine 107 to perform iterative cycles of model validation and model refinement. As discussed in further detail below, machine learning engine 115 may be exemplified by system 300 in FIG. 3, or machine learning platform 225 in FIG. 2.

According to some embodiments, machine learning engine 115 may comprise computer vision engine 115a. In some embodiments, computer vision engine 115a may be used by object identification engine 103 or key frame data identification engine 105 for object identification or key frame data identification.

According to some embodiments, machine learning engine 115 may comprise language model engine 115b. In some embodiments, language model engine 115b may select one or more language models and provide access to language processing engine 201 as shown in FIG. 2. In some embodiments, language model engine 115b may select one or more language models for training ML models 248 as shown in FIG. 2.

According to some embodiments, system 100 may comprise data storage 120. In some embodiments, data storage 120 may comprise a local data server or data storage medium, as exemplified by storage devices 414 and servers 410, 430 in FIG. 4. In some embodiments, data storage 120 may comprise cloud-based storage. In some embodiments, data storage 120 may comprise a hybrid storage. Data storage 120 may comprise object data 120a. Object data 120a may comprise data associated with one or more identified objects based on object identification engine 103 or one or more classified objects based on object analysis engine 107. In some embodiments, attribute tagging engine 109 may store object attribute data (e.g., by tagging the object) based on the output of object analysis engine 107 in data storage 120. In some embodiments, object registration engine 111 may register new object data based on the output of object analysis engine 107 in data storage 120.

FIG. 2 is a block diagram illustrating various exemplary components of a language processing engine comprising language processing modules, according to some embodiments of the present disclosure.

System 200 or one or more of its components may reside on either server 410 or 430 and may be executed by processors 416 or 417. In some embodiments, the components of system 200 may be spread across multiple servers 410 and 430. For example, language processing engine 201 may be executed on multiple servers. Similarly, interaction miner 203 or machine learning platform 225 may be maintained by multiple servers 410 and 430.

As illustrated in FIG. 2, a language processing engine 201 may perform analysis of text data associated with one or more objects identified by object identification engine 103. Language processing engine 201 may receive input text data from object identification engine 103 or key frame data identification engine 105. In some embodiments, language processing engine 201 may receive input text data from data storage 120. In some embodiments, language processing engine 201 may interact with object identification engine 103 or key frame data identification engine 105 to perform object analysis. In some embodiments, language processing engine 201 may be exemplified by language processing engine 107a as shown in FIG. 1. In some embodiments, text data may comprise of a text label or a text description associated with the one or more identified objects. For instance, in a healthcare setting, language processing engine 201 may perform analysis of a text-based label on a medication container (e.g., a medication bottle), which has been identified by object identification engine 103 or key frame data identification engine 105. As another example, language processing engine 201 may perform analysis of a set of physician's instructions or a set of patient's medical history associated with one or more medical objects identified by object identification engine 103. In some embodiments, natural language processing engine 201 may include, but are not limited to, a labelling module 230, or a data processing module 240. Natural language processing engine 201 may perform natural language processing based on one or more corpus databases as exemplified by corpus database 250, or a mining repository as exemplified by mining repository 246.

Language processing engine 201 may include interaction miner 203 to determine labels to associate with received input text data. Language processing engine 201 may use additional configuration details. Interaction miner 203 may include labeling module 230 and data processing module 240 to determine labels. Interaction miner 203 may use a corpus database 250 to store and access various labels of text data. In some embodiments, corpus database 250 may be exemplified by data storage 120 as illustrated in FIG. 1. Interaction miner 203 may use mining repository 246 to get the definitions of tasks and models to generate labels. In some embodiments, language processing engine 201 may interact with language model engine 115b as illustrated in FIG. 1 to access one or more language models. In some embodiments, language processing engine 201 may interact with a machine learning platform 225 as exemplified by machine learning engine 115 as shown in FIG. 1 or machine learning model system 300 as shown in FIG. 3. In some embodiments, language processing engine 201 may generate labels semi-supervised or unsupervised using an accessed language model and a machine learning model.

Language processing engine 201 may also interact with a machine learning platform 225 to help determine labels to associate with received input text data. In some embodiments, machine learning engine 225 may be exemplified by machine learning engine 115a as in FIG. 1 or system 300 as in FIG. 3. Interaction miner 203 and machine learning platform 225 may access data and configurations in corpus database 250 and mining repository 246 to generate labels for the received input data. For instance, in a healthcare setting, language processing engine 201 may generate labels for the received input data (e.g., a medication label on a medication container, a set of physician instructions, or the patient's medical history). In some embodiments, the labels for the received input data may be used to identify relevant fields relating to a medication (e.g., name of medication, dosing, indications, warnings, etc), patient demographical information (e.g., name, age, address), or patient history (e.g., current medical conditions, allergies).

Labeling module 230 may aid in labeling received input text data. Labeling module 230 may store parts of the received input text data along with generated labels in corpus database 250. Labeling module 230 may include manual processing of received input text data using annotator 231 and automatic and real-time processing of received input text data using tagger 232 to generate labels. In some embodiments, labeling module 230 may be configured to generate different labels and types of labels for matching data. Configurations may include configurations for annotator 231 and tagger 232 and stored in corpus database 250.

Annotator 231 may help annotate received input text data by providing a list of annotations to use with the content in the received input text data. Annotator 231 may be configured to include the list of annotations to process with a list of annotators. Annotator 231 may receive a configuration (e.g., from a configuration file) over a network (not shown). The configuration file may be a text file or a structured document such as a YAML or JSON. In some embodiments, the configuration file may include a list of documents or a database query to select the list of documents. In some embodiments, a list of documents may be presented as a regex formula to match a set of documents. The configuration file may include additional details for annotations in mining repository 246.

Tagger 232 may automatically tag data with labels using machine learning model platform 225. Language processing engine 220 may train tagger 232 using data annotated with labels provided by annotator 231. In some embodiments, tagger 232 may be used with unstructured data and need auto labeling of the data.

Data processing module 240 takes as input received input text data and labels provided by annotator 231 and tagger 232 to generate insights about the contents of input text data. In some embodiments, insights may represent potential interactions between two or more labelled entities within the data. For instance, in a healthcare setting, insights may be generated to associate one or more medical data fields (e.g., the name, dosing, instruction of a medication) with one or more objects identified by object identification engine 103 or key frame data identification engine 105, as shown in FIG. 1. Data processing module 240 may store the insights in corpus database 250.

Data processing module 240 may use parser 242, which can receive input text data. Parser 242 may retrieve data from multiple data sources as exemplified by external data 120b of data storage 120 as illustrated in FIG. 1. In some embodiments, parser 242 may process the data to documents 252 so that it may be used with the remainder of language processing engine 220. Parser 242 may further include extractor 243, transformer 244, and loader 245 modules. Extractor 243 and transformer 244 may work together to generate documents 252 and other data in corpus database 250. Transformer 244 may connect the disparate data extracted from multiple data sources by extractor 243 and store it in corpus database 250.

Extractor 243 may receive input text data. Parser 242 may retrieve data from multiple data sources as exemplified by external data 120b of data storage 120 as illustrated in FIG. 1. For instance, in a healthcare setting, a data source may represent structured data such as hierarchical topics selected by a service provider communicating with a patient or a user or a usage log of a service by a user. In some embodiments, data sources may be flat files, such as patient's medical history or clinical encounter transcript data (e.g., call data or web data). Further, data sources may contain overlapping or completely disparate data sets. In some embodiments, a data source may contain information about a user usage log of a service. In contrast, other data sources may contain various disparate topics a user discussed with a service provider. Extractor 243 may interact with the various data sources, retrieve the relevant data, and provide that data to transformer 244.

Transformer 244 may receive data from extractor 243 and process the data into standard formats. In some embodiments, transformer 244 may normalize data such as date data, numerical data, or abbreviated data. For instance, in a healthcare setting, transformer 244 may normalize data relating to a medication such as its generic or brand name, prescription strength, dosing instructions, and warnings. Transformer 244 may modify the received input text data through extractor 243 into a consistent data format. For instance, transformer 244 may use extractor 243 to modify a set of instructions for taking a medication “twice daily” and “B.I.D.” into a consistent data format. Transformer 244 may effectively clean the data provided through extractor 243 so that all of the data, although originating from a variety of sources, has a consistent format. In some embodiments, transformer 244 may also supplement partial or incomplete data based on data from storage 120 as illustrated in FIG. 1. For instance, in a healthcare setting, if the received input text data associated with one or more objects comprise only the partial name of the medication or the patient's name, transformer 244 may perform data look-up and retrieval from data storage 120 for automatic data completion.

Moreover, transformer 244 may extract additional data points from the data sent by extractor 243. For example, in a healthcare setting, transformer 244 may process a set of instructions for taking a medication by extracting separate data fields for the frequency (e.g., “twice daily” or “B.I.D.”), and the route of administration (e.g. “P.O.”). Transformer 244 may also perform other linear and non-linear transformations and extractions on categorical and numerical data, such as normalization and demeaning. Transformer 244 may provide the transformed or extracted data to loader 245. In some embodiments, transformer 244 may store the transformed data in corpus database 250 for later use by loader 245 and other components of interaction miner 203.

Loader 245 may receive normalized data from transformer 244. Loader 245 may merge the data into varying formats depending on the specific requirements of language processing engine 201 and store the data in an appropriate storage mechanism such as corpus database 250. Loader 245 may store received input text data processed by various components of parser 242 as documents 252.

Corpus database 250 may include raw input data stored as documents 252 and configurations to label documents as configs 251.

Configs 251 may include configuration parameters to determine labels to associate with documents 252 and generate insights of interaction content in documents 252. Configs 251 may include a configuration file sent over a network. Configs 251 may include flat files in an unstructured format as text files or semi-structured XML or JSON files. In some embodiments, configs 251 may include parsed content from a configuration file. Configs 251 may store parsed content as database tables.

Mining repository 246 may include various configurations and definitions for extracting relevant parts from input text data to store in corpus database 250. Mining repository 246 may include annotation tasks 247 and ML models 248 to define and assign labels to content in documents 252.

Annotation tasks 247 include definitions of annotations to add as labels to documents 252. A user of language processing engine 201 may provide definitions of annotations as part of a configuration file (e.g., configs 251).

ML Models 248 may include machine learning models trained by interaction miner 223 using machine learning model platform 225. In some embodiments, machine learning model platform 225 may be exemplified by machine learning engine 115 in FIG. 1 or system 300 in FIG. 3. ML models 248 may be trained using training data in corpus database 250. ML models 248 may be configured using configs 251 and set up for training using annotation tasks 247. Annotations identified using annotation tasks 247 may be used as training data for ML models 248. In some embodiments, ML models 248 may be trained based on accessing one or more language models by language model engine 115b in FIG. 1.

In various embodiments, corpus database 250, mining repository 246, as well as object data 120a and external data 120b in FIG. 1, may take several different forms. For example, mining repository 246 may be an SQL or NoSQL database, such as those developed by MICROSOFT™, REDIS, ORACLE™, CASSANDRA, MYSQL, various other types of databases, data returned by calling a web service, data returned by calling a computational function, sensor data, IoT devices, or various other data sources. Corpus database 250 may store data that is used during the operation of applications, such as interaction miner 203. In some embodiments, corpus database 250 and mining repository 246 may be fed data from an external source, or the external source (e.g., server, database, sensors, IoT devices, etc.) may be a replacement. In some embodiments, the external source may comprise data as exemplified by external data 120b in FIG. 1. In some embodiments, corpus database 250 may be data storage for a distributed data processing system (e.g., Hadoop Distributed File System, Google File System, ClusterFS, or OneFS). Depending on the specific embodiment of corpus database 250, interaction miner 203 may optimize the label data for storing and retrieving in corpus database 250 for optimal query performance.

FIG. 3 is a block diagram illustrating an exemplary machine learning platform for implementing various aspects of this disclosure, according to some embodiments of the present disclosure.

System 300 or one or more of its components may reside on either server 410 or 430 and may be executed by processors 416 or 417. In some embodiments, the components of system 200 may be spread across multiple servers 410 and 430. For example, data input engine 310 may be executed on multiple servers. Similarly, featurization engine 320, ML modeling engine 330, predictive output generation engine 340, output validation engine 350, and model refinement engine 360 may be maintained by multiple servers 410 and 430.

System 300 may include data input engine 310 that can further include data retrieval engine 304 and data transform engine 306. Data input engine 310 may be configured to access, interpret, request, format, re-format, or receive input data from data source(s) 302. Data source(s) 302 may include one or more of training data 302a (e.g., input data to feed a machine learning model as part of one or more training processes), validation data 302b (e.g., data against which system may compare model output with, such as to determine model output quality), or reference data 302c. In some embodiments, data input engine 310 can be implemented using at least one computing device or server environment as exemplified by system 400 of FIG. 4. For example, data from data sources 302 can be obtained through one or more I/O devices or network interfaces. Further, the data may be stored (e.g., during execution of one or more operations) in a suitable storage or system memory. Data input engine 310 may also be configured to interact with data storage 120 as in FIG. 1, which may be implemented on a computing device that stores data in storage or system memory. System 300 may include featurization engine 320. Featurization engine 320 may include feature annotating & labeling engine 312 (e.g., configured to annotate or label features from a model or data, which may be extracted by feature extraction engine 314), feature extraction engine 314 (e.g., configured to extract one or more features from a model or data), or feature scaling and selection engine 316. System 300 may also include machine learning (ML) modeling engine 330, which may be configured to execute one or more operations on a machine learning model (e.g., model training, model re-configuration, model validation, model testing), such as those described in the processes described herein. For example ML modeling engine 330 may execute an operation to train a machine learning model, such as adding, removing, or modifying a model parameter. Training of a machine learning model may be supervised, semi-supervised, or unsupervised. Data into to a model to train the model may include input data (e.g., as described above) or data previously outputted from a model (e.g., forming recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters or models, which may be dependent or interdependent, hierarchical, or static or dynamic. ML modeling engine 330 may include model selector engine 332 (e.g., configured to select a model from among a plurality of models, such as based on input data), parameter selector engine 334 (e.g., configured to add, remove, or change one or more parameters of a model), or model generation engine 336 (e.g., configured to generate one or more machine learning models, such as according to model input data, model output data, comparison data, or validation data). Similar to data input engine 310, featurization engine 320 can be implemented on a computing device. In some embodiments, model selector engine 332 may be configured to receive input or transmit output to ML algorithms database 390 (e.g., a data storage 308). Similarly, featurization engine 320 can utilize storage or system memory for storing data and can utilize one or more I/O devices or network interfaces for transmitting or receiving data. ML algorithms database 390 (or other data storage 308) may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a Proximal Policy Optimization (PPO) model, a nearest neighbor model, a linear regression model, a k-means clustering model, a Q-Learning model, a Temporal Difference (TD) model, a Deep Adversarial Network model, or any other type of model described further herein.

System 300 can further include predictive output generation engine 340, output validation engine 350 (e.g., configured to apply validation data to machine learning model output), feedback engine 370 (e.g., configured to apply feedback from a user or machine to a model), and model refinement engine 360 (e.g., configured to update or re-configure a model). In some embodiments, feedback engine 370 may receive input or transmit output to outcome metrics database 380. In some embodiments, model refinement engine 360 may receive output from predictive output generation engine 340 or output validation engine 350. In some embodiments, model refinement engine 360 may transmit the received output to featurization engine 320 or ML modeling engine 330 in one or more iterative cycles.

Any or each engine of system 300 may be a module (e.g., a program module), which may be a packaged functional hardware unit designed for use with other components or a part of a program that performs a particular function (e.g., of related functions). Any or each of these modules may be implemented using a computing device. In some embodiments, the functionality of system 300 may be split across multiple computing devices to allow for distributed processing of the data, which may improve output speed and reduce computational load on individual devices. In these or other embodiments, the different components may communicate over one or more I/O devices or network interfaces.

System 300 can be related to different domains or fields of use. Descriptions of embodiments related to specific domains, such as natural language processing as exemplified by natural language processing engine 201 as shown in FIG. 2 or language modeling as exemplified by language modeling engine 115b as shown in FIG. 1, is not intended to limit the disclosed embodiments to those specific domains, and embodiments consistent with the present disclosure can apply to any domain that utilizes predictive modeling based on available data.

FIG. 4 illustrates a schematic diagram of an exemplary server of a distributed system, according to some embodiments of the present disclosure.

According to FIG. 4, server 410 of distributed computing system 400 comprises a bus 412 or other communication mechanisms for communicating information, one or more processors 416 communicatively coupled with bus 412 for processing information, and one or more main processors 417 communicatively coupled with bus 412 for processing information. Processors 416 can be, for example, one or more microprocessors. In some embodiments, one or more processors 416 comprises processor 465 and processor 466, and processor 465 and processor 466 are connected via an inter-chip interconnect of an interconnect topology. Main processors 417 can be, for example, central processing units (“CPUs”).

Server 410 can transmit data to or communicate with another server 430 through a network 422. Network 422 can be a local network, an internet service provider, Internet, or any combination thereof. Communication interface 418 of server 410 is connected to network 422, which can enable communication with server 430. In addition, server 410 can be coupled via bus 412 to peripheral devices 440, which comprises displays (e.g., cathode ray tube (CRT), liquid crystal display (LCD), touch screen, etc.) and input devices (e.g., keyboard, mouse, soft keypad, etc.).

Server 410 can be implemented using customized hard-wired logic, one or more ASICs or FPGAs, firmware, or program logic that in combination with the server causes server 410 to be a special-purpose machine.

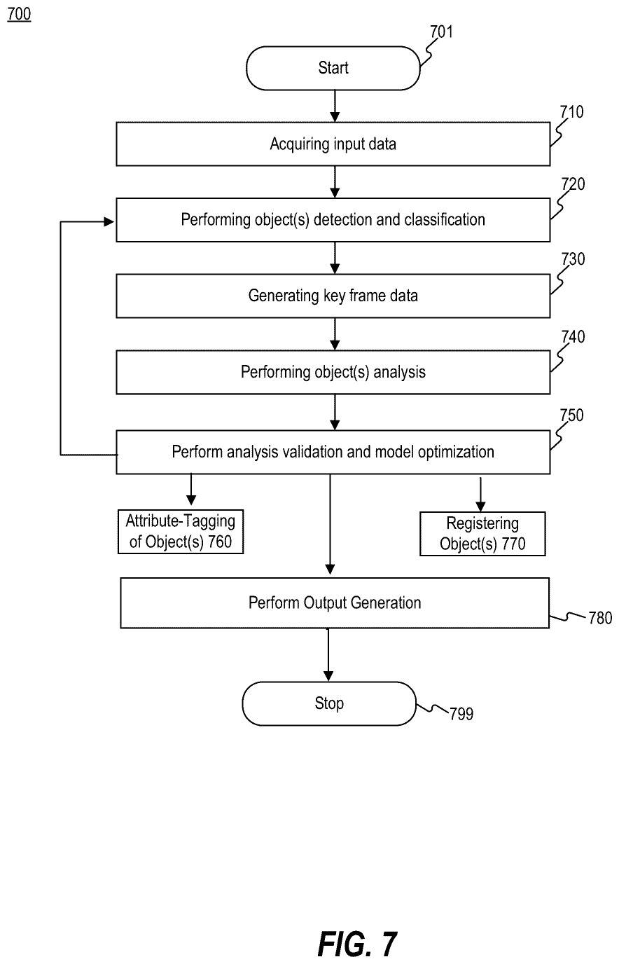

Server 410 further comprises storage devices 414, which may include memory 461 and physical storage 464 (e.g., hard drive, solid-state drive, etc.). Memory 461 may include random access memory (RAM) 462 and read-only memory (ROM) 463. Storage devices 414 can be communicatively coupled with processors 416 and main processors 417 via bus 412. Storage devices 414 may include a main memory, which can be used for storing temporary variables or other intermediate information during execution of instructions to be executed by processors 416 and main processors 417. Such instructions, after being stored in non-transitory storage media accessible to processors 416 and main processors 417, render server 410 into a special-purpose machine that is customized to perform operations specified in the instructions. The term “non-transitory media” as used herein refers to any non-transitory media storing data or instructions that cause a machine to operate in a specific fashion (e.g., such as the functionalities described herein including the functionality provided in FIG. 7). Such non-transitory media can comprise non-volatile media or volatile media. Non-transitory media include, for example, optical or magnetic disks, dynamic memory, a floppy disk, a flexible disk, hard disk, solid state drive, magnetic tape, or any other magnetic data storage medium, a CD-ROM, any other optical data storage medium, any physical medium with patterns of holes, a RAM, a PROM, and an EPROM, a FLASH-EPROM, NVRAM, flash memory, register, cache, any other memory chip or cartridge, and networked versions of the same.

Various forms of media can be involved in carrying one or more sequences of one or more instructions to processors 416 or main processors 417 for execution. For example, the instructions can initially be carried out on a magnetic disk or solid-state drive of a remote computer. The remote computer can load the instructions into its dynamic memory and send the instructions over a telephone line using a modem. A modem local to server 410 can receive the data on the telephone line and use an infra-red transmitter to convert the data to an infra-red signal. An infra-red detector can receive the data carried in the infra-red signal, and appropriate circuitry can place the data on bus 412. Bus 412 carries the data to the main memory within storage devices 414, from which processors 416 or main processors 417 retrieves and executes the instructions.

System 100 or one or more of its components may reside on either server 410 or 430 and may be executed by processors 416 or 417. In some embodiments, the components of system 100 may be spread across multiple servers 410 and 430. For example, object identification engine 103 may be executed on multiple servers. Similarly, object analysis engine 107, output generation engine 113, or machine learning engine 115 may be maintained by multiple servers 410 and 430.

FIG. 5 illustrates an exemplary process using for example system 100 for identifying and analyzing a medical object, and generating output, according to some embodiments of the present disclosure.

As shown in FIG. 5A, an exemplary system such as system 100 in FIG. 1 may receive input data (e.g., by capturing video data using a mobile device) and identify one or more objects within the receive input data. As shown in FIG. 5A, system 100 may perform object identification based on one or more confidence metrics and generate one or more labels associated with the identified objects based on a confidence level from the one or more confidence metrics. In some embodiments, system 100 may perform object identification when the confidence level from the one or more confidence metrics is above a certain threshold. In this instance, system 100 is able to identify “oven” and “cup” based on a confidence level above a threshold of 0.9 (i.e., 90%).

As shown in FIG. 5B, exemplary system 100 may detect medication bottle when it comes into the center of view of the user (e.g., via the user's interaction with video data such as through a mobile device's camera or video app). System 100 may perform object identification based on one or more confidence metrics and generate one or more labels associated with the identified objects based on a confidence level from the one or more confidence metrics. In some embodiments, system 100 may perform object identification when the confidence level from the one or more confidence metrics is above a certain threshold. For instance, as in FIG. 5B, system 100 may label the detected object as “med bottle” when the confidence level for object identification is above a threshold of 0.9 (i.e., 90%).

As shown in FIG. 5C, exemplary system 100 may perform object analysis based on the identified object (e.g., “med bottle”) from FIG. 5B. For instance, system 100 may perform context analysis using context analysis engine 107b in FIG. 1 to identify the label associated with the medication bottle. System 100 may also perform language processing on the identified label using language processing engine 107a to determine the content of the medication bottle. For instance, system 100 may determine patient information such as name (e.g., “John Smith”), age, DOB, address, past medical history, known allergies, or the name of the medication (e.g., “Amoxicillin/Clavulanate,” the brand name (e.g., “Augmentin”), the dosage, indications (e.g., “bronchitis”), and directions (“take one tablet by mouth every 12 hours for 10 days.”)

As shown in FIG. 5D, exemplary system 100 may then generate output to the user based on extracted data from object analysis and identification. For instance, system 100 may generate output to the user in the form of an augmented-reality visual overlay (e.g., “John Smith Augmentin 875 mg 1 by mouth every 12 hours”) associated with the object. In some embodiments, system 100 may generate output onto a mobile display or a wearable device. In some embodiments, the augmented-reality visual overlay may track with the object in 3D space and the user's field-of-view. In some embodiments, system 100 may tag or register an identified object with extracted data and store the data in an exemplary data storage medium such as data storage 120 as shown in FIG. 1.

FIG. 6 illustrates an exemplary process using for example system 100 for identifying and analyzing a medical object, and generating output, according to some embodiments of the present disclosure.

As shown in FIG. 6A, an exemplary system such as system 100 in FIG. 1 may receive input data (e.g., by capturing video data using a mobile device) and identify one or more objects within the receive input data. As shown in FIG. 6A, system 100 may perform object identification based on one or more confidence metrics and generate one or more labels associated with the identified objects based on a confidence level from the one or more confidence metrics. In some embodiments, system 100 may perform object identification when the confidence level from the one or more confidence metrics is above a certain threshold. In this instance, system 100 is able to identify “oven” and “cup” based on a confidence level above a threshold of 0.9 (i.e., 90%).

As shown in FIG. 6B, exemplary system 100 may detect medication bottle when it comes into the center of view of the user (e.g., via the user's interaction with video data such as through a mobile device's camera or video app). System 100 may perform object identification based on one or more confidence metrics and generate one or more labels associated with the identified objects based on a confidence level from the one or more confidence metrics. In some embodiments, system 100 may perform object identification when the confidence level from the one or more confidence metrics is above a certain threshold. For instance, as in FIG. 6B, system 100 may label the detected object as “med bottle” when the confidence level for object identification is above a threshold of 0.9 (i.e., 90%).

As shown in FIG. 6C, exemplary system 100 may perform object analysis based on the identified object (e.g., “med bottle”) from FIG. 6B. For instance, system 100 may perform context analysis using context analysis engine 107b in FIG. 1 to identify the label associated with the medication bottle. System 100 may also perform language processing on the identified label using language processing engine 107a to determine the content of the medication bottle. For instance, system 100 may determine patient information such as name (e.g., “John Smith”), age, DOB, address, past medical history, known allergies, or the name of the medication (e.g., “Amoxicillin/Clavulanate,” the brand name (e.g., “Augmentin”), the dosage, indications (e.g., “bronchitis”), and directions (“take one tablet by mouth every 12 hours for 10 days.”)

As shown in FIG. 6D, exemplary system 100 may then generate output to the user based on extracted data from object analysis and identification. For instance, system 100 may generate output to the user in the form of an augmented-reality visual overlay (e.g., “John Smith Augmentin 875 mg 1 by mouth every 12 hours”) associated with the object. In some embodiments, system 100 may generate output onto a mobile display or a wearable device. In some embodiments, the augmented-reality visual overlay may track with the object in 3D space and the user's field-of-view. In some embodiments, system 100 may tag or register an identified object with extracted data and store the data in an exemplary data storage medium such as data storage 120 as shown in FIG. 1.

FIG. 7 is a flow diagram illustrating an exemplary process for identifying and analyzing objects (e.g., medical objects such as a medication bottle), according to some embodiments of the present disclosure. In some embodiments, the process can be performed by a system (e.g., system 100 of FIG. 1).

In some embodiments, process 700 begins at step 710. In step 710, the system may acquire input data. The system may receive input data from one or more data sources such as an imaging device (e.g., a camera on a mobile phone) or from a wearable device such as an AR/VR (virtual-reality/augmented-reality) headset. The system may receive image or video data from one or more data sources. The system may normalize the received data. In some embodiments, data normalization comprises normalizing various parameters of the received data such as the data format, length, and quality.

At step 720, the least one processor may perform detection and classification of one or more objects within the input data. In some embodiments, the system may identify one or more objects within the received input data. For instance, in a healthcare setting, the system may identify one or more medical objects (e.g., a medication bottle, a medical instrument, a medical chart, or a set of written instructions from the physician). In some embodiments, the system may detect one or more objects within the received input data. The system may perform object detection within the received input data using machine learning engine 115. In some embodiments, the system may perform object detection using computer vision engine 115a. In some embodiments, the system may perform object detection based on one or more confidence metrics and generate one or more labels associated with the identified objects based on a confidence level from the one or more confidence metrics. In some embodiments, the one or more confidence metrics may be used by machine learning engine 115, computer vision engine 115a, or language model engine 115b. The one or more confidence metrics may be stored in data storage 120. In some embodiments, the system may perform object detection and object labeling when the confidence level from the one or more confidence metrics is above a certain threshold. In some embodiments, a confidence metric may be based on environment data (e.g., generated by environment detection engine 103b). For instance, the detection of a “kitchen” environment by environment detection engine 103b may be used by a confidence metric to generate a (e.g. higher) confidence level for objects such as “oven” and “cup.” As another example, the system may detect medication pills based on recognition of its unique shape, size, color, or etched label.

Also in step 720, the system may identify the surrounding environment associated with one or more objects. For instance, the system may detect the real world environment associated one or more objects within the received input data (e.g., image data or video data), such as a kitchen, office, hospital, etc. In some embodiments, the system may perform environment detection and labeling (e.g., “kitchen,” “office,” “hospital”) when a confidence level from one or more confidence metrics is above a certain threshold.

Also in step 720, the system may synthesize data from different sources. In some embodiments, the system may receive data from one or more engines. In some embodiments, the system may transmit data to one or more engines. For instance, the system may receive environment data from environment detection engine 103b and transmit the data to object detection engine 103a. The system may then perform object detection or labeling based on a confidence level from a confidence metric based on the transmitted environment data. For instance, the system may detect and label objects such as “oven” and “cup” with a higher confidence level based on the transmitted environment data comprising “kitchen.” In some embodiments, the system may receive or transmit data from data storage 120.

Also in step 720, the system may perform classification of objects detected by object detection engine 103a. In some embodiments, the system may generate one or more labels associated with the identified objects based on one or more confidence metrics and a confidence level from the one or more confidence metrics. In some embodiments, the one or more confidence metrics may be used by machine learning engine 115, computer vision engine 115a, or language model engine 115b. The one or more confidence metrics may be stored in data storage 120. In some embodiments, the system may classify the one or more identified objects using a classification scheme stored in data storage 120. For instance, in a healthcare setting, a classification scheme may comprise of a list of current medications associated with a user of system 100 based on user data (e.g., “John [user A]'s Augmentin medication”), or a list of medical devices, instruments, or equipment. In some embodiments, user data may be stored in data storage 120. In some embodiments, the classification scheme may be based on environment data from environment detection engine 103b. For instance, as illustrated in FIG. 5 and FIG. 6 and discussed below, the system may classify objects based on a classification scheme (e.g., a medication bottle) and label the detected objects accordingly as “med bottle” based on the classification. The system may further classify an object such as “med bottle” based on user data (e.g., “John [user A]'s med bottle”).

Also in step 720, the system may perform object tracking and object validation, as discussed with respect to object identification engine 103 in FIG. 1.

At step 730, the system may identify key frame data. In some embodiments, For instance, for input data comprising video data (e.g., acquired via a video recording device or a camera mobile app), the system may identify a key video frame within the video input data containing objects of relevance. For instance, for video input data, key frame data may comprise one or more video frames where one or more objects have been detected or classified by object identification engine 103 (e.g., a “cup,” an “oven,” or a “med bottle.”) In some embodiments, the system may identify key frame data based on environment data. The system may interact with machine learning engine 115 and computer vision engine 115a to execute iterative cycles of key frame data identification, validation, and refinement, as illustrated in exemplary machine learning system 300 in FIG. 3. In some embodiments, the system may identify key frame data based on one or more confidence metrics associated with one or more identified or classified objects from object identification engine 103. For instance, the system may identify key frame data comprising data associated with identified or classified objects having a confidence level above a certain threshold (e.g., 0.9 or 90%). In some embodiments, the system may identify key frame data based on external data (e.g., user-defined data) stored in data storage 120. For instance, key frame data may be identified based on user specification of specific objects of relevance (e.g., a medication bottle associated with a user, such as “John [user A]'s Augmentin medication.”).

At step 740, the system may perform object analysis. The system may receive object detection data or environment data from object identification engine 103. The system may receive key frame data from key frame data identification engine 105. The system may analyze one or more identified objects to generate relevant analysis data. For instance, in a healthcare setting, the system may analyze an identified medication bottle to generate analysis data based on the label on the medication bottle (e.g., comprising the name of the medication, instructions, contraindications, etc).

At step 750, the system may perform iterative cycles of object analysis, validation, and model refinement or optimization. In some embodiments, the least one processor may execute performance using machine learning engine 115. The system may generate output data for additional output generation by output generation engine 113. The system may generate output object data for attribute-tagging by attribute tagging engine 109, or for registration by object registration engine 111.

At step 760, the system may perform attribute-tagging of one or more analyzed objects. The system may receive output analysis data and identify relevant attributes associated with one or more objects of interest. For instance, in a healthcare setting, the system may identify a set of attributes associated with a medication bottle (e.g., “med bottle”) such as the name of the medication, the name of the patient (e.g. user) for whom the medication is prescribed, the instructions for taking the medications, and any associated warnings. The system may attach the set of attributes to the object of interest. For instance, the attached attributes may be transmitted to Augmented Reality display engine 113a to be displayed as an AR overlay of the object of interest (e.g., the medication bottle) via a user's camera mobile device or a wearable. The attached attributes may also be transmitted to accessibility engine 113b (e.g., a text to speech system), or data interaction engine 113c for further processing of the attributes (i.e., for generating audio output or for transmitting the data to an electronic healthcare system).

At step 770, the system may perform registration of one or more analyzed objects. In some embodiments, the system may receive output analysis data from object analysis engine 107 and access a database such as one exemplified by data storage 120. The system may register object data by storing output analysis data associated with one or more objects in data storage 120. The system may update object data 120a based on output analysis data.

At step 780, the at least one processor may perform output generation based on object analysis data. The system may receive object analysis data from object analysis engine 107 and generate output directed to various formats and output devices (e.g., VR/AR display, Text-to-Speech systems, or data transmission to electronic healthcare systems). In some embodiments, the system may generate AR display based on the output analysis data. As illustrated in FIG. 5D and FIG. 6D, the system may generate an AR overlay display over input video data (e.g., acquired via a camera or video app on a mobile device or a wearable device) containing information relevant to an object of interest. For instance, as shown in FIGS. 5D and 6D, the system may generate an AR display over the detected object (e.g., a medication bottle) containing the name of the patient (i.e., the user), the name of the medication, and the instructions for taking the medication.

Also in step 780, the system may access one or more systems to assist a user with disabilities, such as a text to speech system. In some embodiments, the system may transmit output analysis data from object analysis engine 107 to external applications such as mobile apps, computer programs, or other database systems. For instance, in a healthcare setting, the system may transmit object analysis data comprising medication data associated with user (e.g., John [user A]'s Augmentin) to an external healthcare database for verification or updating. As another example, the system may transmit output analysis data relating to an object (e.g., a medical object such as a medication bottle) to a mobile app such as a scheduling or calendar app. The system may enable automatic alerts to the user based on the analyzed object data. For instance, if medication bottle contains instructions for “BID for 10 days,” the system may interact with the user's scheduling or calendar app to automatically generate twice-daily alerts or reminders for 10 days. As another example in the healthcare setting, the system may synthetize analyzed object data with external data 120b (e.g., a user or patient's past medical history, allergies, list of other current medications etc) and generate warnings to the user for potentially dangerous drug combinations or contraindications. As another example, the system may transmit output analysis data (e.g., medication data, healthcare data, or patient demographic data) to an electronic form for automatic completion, or to a healthcare provider for further management.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct one or more hardware processors of a computer, other programmable data processing apparatus, or other devices to function in a particular manner, such that the instructions stored in the computer readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer readable medium(s) may be utilized. The computer readable medium may be a non-transitory computer readable storage medium. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, IR, etc., or any suitable combination of the foregoing.

Computer program code for carrying out operations, for example, embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate examples of the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A system comprising:
at least one memory storing instructions;
the system configured to execute the instructions to cause the system to perform operations for automatically identifying and analyzing objects, the operations comprising:
receiving input data that comprises image data having a plurality of objects;
identifying, from the image data, an object of interest of the plurality of objects;
identifying key frame data from the image data based on the identified object of interest; and
analyzing, from the key frame data, the identified object of interest using one or more machine learning models.

2. The system of claim 1, wherein the image data comprises a sequence of images corresponding to video data.

3. The system of claim 1, wherein receiving input data further comprises acquiring data and normalizing data.

4. The system of claim 1, wherein identifying one or more objects associated with the input data comprises detecting, tracking, or classifying the one or more objects.

5. The system of claim 1, wherein generating the key frame data is based on one or more confidence metrics associated with the one or more objects.

6. The system of claim 1, wherein analyzing the identified objects further comprises language processing or context analysis based on the key frame data.

7. The system of claim 1, wherein analyzing the identified objects comprises extracting or parsing text data from the key frame data.

8. The system of claim 1, wherein analyzing the identified objects further comprises synthesizing text data from a plurality of images within the image data.

9. The system of claim 1, further comprising iteratively executing second operations until a threshold value has been reached to generate an optimal object validation score, wherein the second operations comprise:
analyzing the one or more objects using the one or more machine learning models;
validating the one or more objects;
updating an object validation score based on the validating of the one or more objects; and
refining the one or more machine learning models based on the validation of the one or more objects.

10. The system of claim 1, further comprising tagging the one or more analyzed objects, registering the one or more analyzed objects, or generating output based on the one or more analyzed objects.

11. A method for automatically identifying and analyzing objects, comprising:
receiving input data that comprises image data having a plurality of objects;
identifying, from the image data, an object of interest of the plurality of objects;
identifying key frame data from the image data based on the identified object of interest; and
analyzing, from the key frame data, the identified object of interest using one or more machine learning models.

12. The method of claim 11, wherein the image data comprises a sequence of images corresponding to video data.

13. The method of claim 11, wherein receiving input data further comprises acquiring data and normalizing data.

14. The method of claim 11, wherein identifying one or more objects associated with the input data comprises detecting, tracking, or classifying the one or more objects.

15. The method of claim 11, wherein generating the key frame data is based on one or more confidence metrics associated with the one or more objects.

16. The method of claim 11, wherein analyzing the identified objects further comprises language processing or context analysis based on the key frame data.

17. The method of claim 11, wherein analyzing the identified objects comprises extracting or parsing text data from the key frame data.

18. The method of claim 11, wherein analyzing the identified objects further comprises synthesizing text data from a plurality of images within the image data.

19. The method of claim 11, further comprising iteratively executing second operations until a threshold value has been reached to generate an optimal object validation score, wherein the second operations comprise:
analyzing the one or more objects using the one or more machine learning models;
validating the one or more objects;
updating an object validation score based on the validating of the one or more objects; and
refining the one or more machine learning models based on the validation of the one or more objects.

20. The method of claim 11, further comprising tagging the one or more analyzed objects, registering the one or more analyzed objects, or generating output based on the one or more analyzed objects.
